(19) United States
(12) Patent Application Publication
(10) Pub. No.: US 2007/0043980 A1
(43) Pub. Date: Feb. 22, 2007

(54) Test scenario generation program, test scenario generation apparatus, and test scenario generation method

(75) Inventors: Kyoko Ohashi, Kawasaki (JP); Tadahiro Uehara, Kawasaki (JP); Asako Katayama, Kawasaki (JP); Rieko Yamamoto, Kawasaki (JP); Toshihiro Kodaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/289,412

(22) Filed: Nov. 30, 2005

(30) Foreign Application Priority Data
Aug. 19, 2005 (JP) 2005-238500

(51) Int. Cl. G06F 11/00

(52) U.S. Cl. 714/45

(57) ABSTRACT

The present invention has been made to provide a test scenario generation program, a test scenario generation apparatus, and a test scenario generation method that generate a test scenario that not only covers all paths in the screen transition diagram, but also have various viewpoints.

A test scenario generation program makes a computer execute a test scenario generation method that generates a test scenario for use in verification of an application involving screen change. The test scenario generation program makes the computer execute: a design information acquisition step S11 that acquires design information of the application; a test scenario template information generation step S12 that generates test scenario template information having a part of information of the test scenario based on the design information and a previously set generation rule; and a test scenario setting step S31 that sets the result of the setting that has been made for the test scenario template information based on the design information as the test scenario.

### BACKGROUND OF THE INVENTION

1. Field of the Invention

The present invention relates to a test scenario generation program, a test scenario generation apparatus, and a test scenario generation method that generate a test scenario for use in verification of an application involving screen change.

2. Description of the Related Art

Conventionally, in performing a function test on an application involving screen change, such as a web application, a creator of the application (creator of test scenario) has often created a test scenario based on screen transition information included in design information of the application. The screen transition information is represented by a flow graph in which nodes are made corresponding to respective screens. The flow graph is, in general, referred to as screen transition diagram.

As a prior art relating to the present invention, Jpn. Pat. Appln. Laid-Open Publication No. 9-223040 (hereinafter, referred to as Pat. Document 1) is known. A system test support apparatus for software and a test scenario generation apparatus for use in the system test support apparatus disclosed in Pat. Document 1 have been made to perform a system test for a GUI-based software application with ease. For achieving this object, the system test support apparatus and test scenario generation apparatus generate a test scenario required to cover all states and all state transitions that a GUI section of the software application has.

The technique disclosed in Pat. Document 1 has generated a test scenario so as to cover all state transitions. However, it is not always possible to obtain a satisfactory test scenario for the creator only by giving a function of covering the screen transition to the test scenario. That is, different test scenarios are required even for the same path (transition sequence from start to end) depending on data to be input for the screen or difference in the structure of display items displayed on the screen. Further, what kind of a viewpoint is used to create a test scenario depends on the skill of the creator, resulting in variation in test quality. For example, the number of test scenarios or test data such as input data or expectation values required for performing the test scenario becomes enormous, making it impossible to generate the test data or perform the test scenario, or unintentionally generating a test scenario unnecessary for operation.

Further, in editing a test scenario, the creator must check the validity of test scenario. For example, whether screen transitions are correct, or whether a correct button is used for causing the screen to be switched needs to be checked by the creator. This operation imposes excessive burdens on the creator, resulting in inputting error.

Further, in editing a test scenario, the creator must create test data to be used in the test scenario. The test data needs to conform to the screen item definition included in design information and, on that basis, the creator has to create test data suitable for the test scenario. The screen item definition is one that defines components in the screen. The creator therefore must create the test data while referring to a plurality of documents such as the screen item definition or test scenario; the creator must create the test data corresponding to both a transition source screen and a transition destination screen for each transition; or an amount of the data to be generated is large. In either case, burden on the creator is large.

Further, design information such as the screen transition diagram or screen item definition is likely to be changed after the start of the test scenario generation. When the test scenario is automatically to be generated based on the design information after the change, the test scenario or test data needs to be edited again or it becomes necessary to check the entire test scenario even if the change for the design information is partial one.

### SUMMARY OF THE INVENTION

The present invention has been made to solve the above problem, and an object thereof is to provide a test scenario generation program, a test scenario generation apparatus, and a test scenario generation method that generate a test scenario that not only covers all paths in the screen transition diagram, but also have various viewpoints.

To solve the above problem, according to a first aspect of the present invention, there is provided a test scenario generation program that makes a computer to execute a test scenario generation method that generates a test scenario for use in verification of an application involving screen change, the test scenario generation program making the computer execute: a design information acquisition step that acquires design information of the application; a test scenario template information generation step that generates test scenario template information having a part of information of the test scenario based on the design information acquired by the design information acquisition step and a previously set generation rule; and a test scenario setting step that sets the result of the setting that has been made for the test scenario template information based on the design information as the test scenario.

The test scenario generation program according to the present invention further makes the computer execute, after the test scenario setting step, a test data setting step that sets test data corresponding to the test scenario based on the design information acquired by the design information acquisition step and test scenario set by the test scenario setting step.

The test scenario generation program according to the present invention further makes the computer to execute: a design information reacquisition step that reacquires the design information of the application in the case where the design information of the application has been changed after the test data setting step; and a test scenario template information regeneration step that regenerates the test scenario template information based on the design information reacquired by the design information reacquisition step and generation rule after the design information reacquisition step, determines whether the test scenario template information after the regeneration is identical to the test scenario template information before the regeneration and, in the case where they are identical to each other, uses the test scenario and test data that have been set based on the test scenario template information before the regeneration.

Further, in the test scenario generation program according to the present invention, the generation rule includes any of a rule that regards input data as normal in a screen that receives user's input, a rule that regards input data as abnormal in a screen that receives user's input, a rule that displays the number of items falling within a normal range in a screen in which the number of items to be displayed is variable, a rule that displays the number of items falling out of a normal range in a screen in which the number of items to be displayed is variable, a rule that displays the number of items close to the upper limit of the number of items to be displayed in which the number of items to be displayed is variable, and a rule that displays the number of items close to the lower limit of the number of items to be displayed in which the number of items to be displayed is variable.

Further, in the test scenario generation program according to the present invention, the design information includes a screen transition diagram that represents the screen transition of the application and screen item definition that represents definition of the components in the screen.

Further, in the test scenario generation program according to the present invention, the test scenario template information generation step generates the test scenario template information such that all screen transitions are used at least once and generates the test scenario template information that performs a loop of a predetermined screen transition.

Further, in the test scenario generation program according to the present invention, when a creator makes a setting for the test scenario template information, the test scenario setting step supports the creator's setting operation by presenting options of available setting values to the creator, by restricting the available setting values, or by alerting the creator when he or she sets an abnormal value based on the design information.

Further, in the test scenario generation program according to the present invention, when a creator makes a setting for the test data, the test data setting step supports the creator's setting operation by presenting options of available setting values to the creator, by restricting the available setting values, or by alerting the creator when he or she sets an abnormal value based on the design information.

According to a second aspect of the present invention, there is provided a test scenario generation apparatus that generates a test scenario for use in verification of an application involving screen change, comprising: a design information acquisition section that acquires design information of the application; a test scenario template information generation section that generates test scenario template information having a part of information of the test scenario based on the design information acquired by the design information acquisition section and a previously set generation rule; and a test scenario setting section that sets the result of the setting that has been made for the test scenario template information based on the design information as the test scenario.

The test scenario generation apparatus according to the present invention further comprises a test data setting section that sets test data corresponding to the test scenario based on the design information acquired by the design information acquisition section and test scenario set by the test scenario setting section.

Further, in the test scenario generation apparatus according to the present invention, the design information acquisition section reacquires the design information of the application in the case where the design information of the application has been changed, the test scenario template information generation section regenerates the test scenario template information based on the design information reacquired by the design information acquisition section, and the test scenario generation apparatus further includes a test scenario template information selection section that determines whether the test scenario template information after the regeneration is identical to the test scenario template information before the regeneration and, in the case where they are identical to each other, uses the test scenario and test data that have been set based on the test scenario template information before the regeneration.

Further, in the test scenario generation apparatus according to the present invention, the generation rule includes any of a rule that regards input data as normal in a screen that receives user's input, a rule that regards input data as abnormal in a screen that receives user's input, a rule that displays the number of items falling within a normal range in a screen in which the number of items to be displayed is variable, a rule that displays the number of items falling out of a normal range in a screen in which the number of items to be displayed is variable, a rule that displays the number of items close to the upper limit of the number of items to be displayed in which the number of items to be displayed is variable, and a rule that displays the number of items close to the lower limit of the number of items to be displayed in which the number of items to be displayed is variable.

Further, in the test scenario generation apparatus according to the present invention, the design information includes a screen transition diagram that represents the screen transition of the application and screen item definition that represents definition of the components in the screen.

Further, in the test scenario generation apparatus according to the present invention, the test scenario template information generation section generates the test scenario template information such that all screen transitions are used at least once and generates the test scenario template information that performs a loop of a predetermined screen transition.

Further, in the test scenario generation apparatus according to the present invention, when a creator makes a setting for the test scenario template information, the test scenario setting section supports the creator's setting operation by presenting options of available setting values to the creator, by restricting the available setting values, or by alerting the creator when he or she sets an abnormal value based on the design information.

Further, in the test scenario generation apparatus according to the present invention, when a creator makes a setting for the test data, the test data setting section supports the creator's setting operation by presenting options of available setting values to the creator, by restricting the available setting values, or by alerting the creator when he or she sets an abnormal value based on the design information.

According to a third aspect of the present invention, there is provided a test scenario generation method that generates a test scenario for use in verification of an application involving screen change, comprising: a design information acquisition step that acquires design information of the application; a test scenario template information generation step that generates test scenario template information having a part of information of the test scenario based on the design information acquired by the design information acquisition step and a previously set generation rule; and a test scenario setting step that sets the result of the setting that has been made for the test scenario template information based on the design information as the test scenario.

According to the present invention, it is possible to significantly reduce the burden on the creator and generate a correct test scenario by generating a template of the test scenario based on the design information and test viewpoint.

### BRIEF DESCRIPTION OF THE DRAWINGS

FIG. 1 is a block diagram showing an example of a configuration of a test scenario generation apparatus according to the present invention;

FIG. 2 is a flowchart showing an example of operation of the test scenario generation apparatus according to the present invention;

FIG. 3 is a flow graph showing an example of a screen transition diagram according to an embodiment of the present invention;

FIG. 4 is a class diagram showing an example of a screen item definition according to the embodiment;

FIG. 5 is a view showing an example of a search screen on a web application according to the embodiment;

FIG. 6 is a view showing an example of a search result screen of a web application according to the embodiment;

FIG. 7 is a flowchart showing an example of test scenario template information generation operation according to the present invention;

FIG. 8 is a document showing an example of the test scenario template information according to the embodiment;

FIG. 9 is a flow graph showing an example of the screen transition diagram in which a transition priority setting is effective;

FIG. 10 is a table showing an example of the test scenario template information according to the embodiment;

FIG. 11 is a table showing an example of a test viewpoint according to the embodiment;

FIG. 12 is an example of a Fragment table according to the embodiment;

FIG. 13 is a flowchart showing an example of third test scenario template information generation operation according to the present invention;

FIG. 14 is a view showing a first example of a test scenario setting screen according to the embodiment;

FIG. 15 is a view showing a second example of a test scenario setting screen according to the embodiment;

FIG. 16 is a view showing a third example of a test scenario setting screen according to the embodiment;

FIG. 17 is a view showing a first example of a test data setting screen according to the embodiment; and

FIG. 18 is a view showing a second example of the test data setting screen according to the embodiment.

### DETAILED DESCRIPTION OF THE PREFERRED EMBODIMENTS

An embodiment of the present invention will be described below with reference to the accompanying drawings.

A test scenario generation apparatus according to the present invention generates a test scenario and test data to be used for verifying an application involving screen change. In the embodiment of the present invention, a web application for searching a rental car is used as a target application of the test scenario generation apparatus.

Firstly, a configuration of the test scenario generation apparatus will be described.

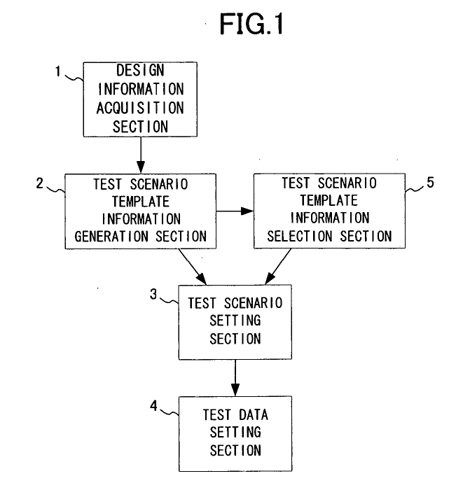

FIG. 1 is a block diagram showing an example of a configuration of the test scenario generation apparatus according to the present invention. The test scenario generation apparatus includes a design information acquisition section 1, a test scenario template information generation section 2, a test scenario setting section 3, a test data setting section 4, and a test scenario template information selection section 5.

An outline of operation of the test scenario generation apparatus according to the present invention will next be described.

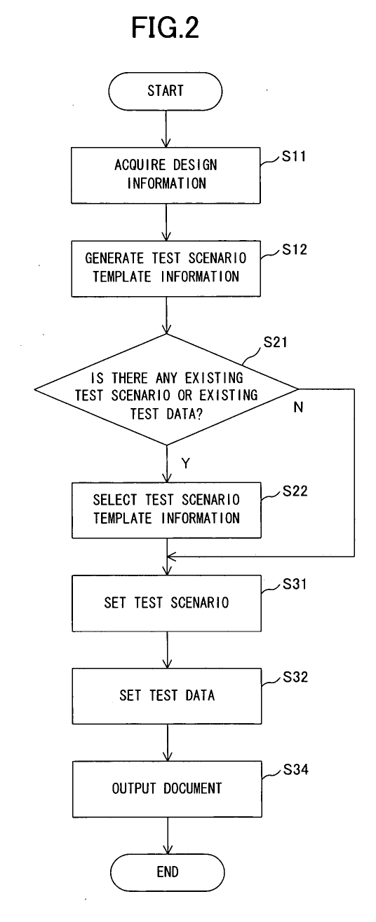

FIG. 2 is a flowchart showing an example of operation of the test scenario generation apparatus according to the present invention. Firstly, the design information acquisition section 1 acquires design information of a target application of the test scenario (S11). The design information includes a screen transition diagram and screen item definition.

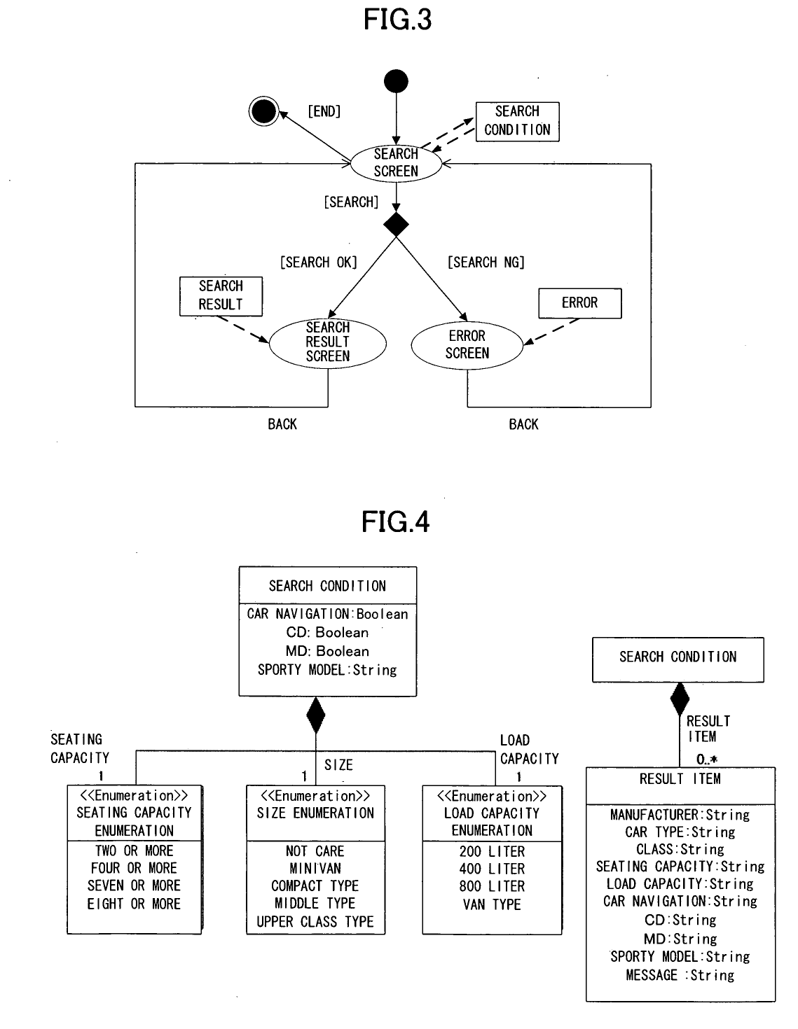

FIG. 3 is a flow graph showing an example of the screen transition diagram according to an embodiment of the present invention. On the screen transition diagram, a screen and data to be input or output for/from the screen are shown. The web application shown in FIG. 3 has a search screen for displaying search condition options that have previously been stored as the screen item definition as well as acquiring a search condition input by a user, a search result screen for displaying search results, and an error screen for displaying an error message. When the web application is started, the search screen is firstly displayed and the user depresses a search button to start searching. When the search result is normal, the search result screen is displayed. The user can go back to the search screen by depressing a back button on the search result screen. On the other hand, when the search result is abnormal, the error screen is displayed. Also in this case, the user can go back to the search screen by depressing a back button on the error screen. FIG. 4 is a class diagram showing an example of the screen item definition according to the embodiment of the present invention. In the class diagram, search conditions representing basic conditions, which are input by the user, are defined as a parent class, and detailed conditions of seating capacity, size, load capacity, which are added to the search conditions, are defined as a child class in an aggregation relationship. Further, a search result serving as a field that displays the search result one by one on the search result screen is defined as a parent class, and a result item which is a detailed item that represents the content of the search result is defined as a child class in an aggregation relationship.

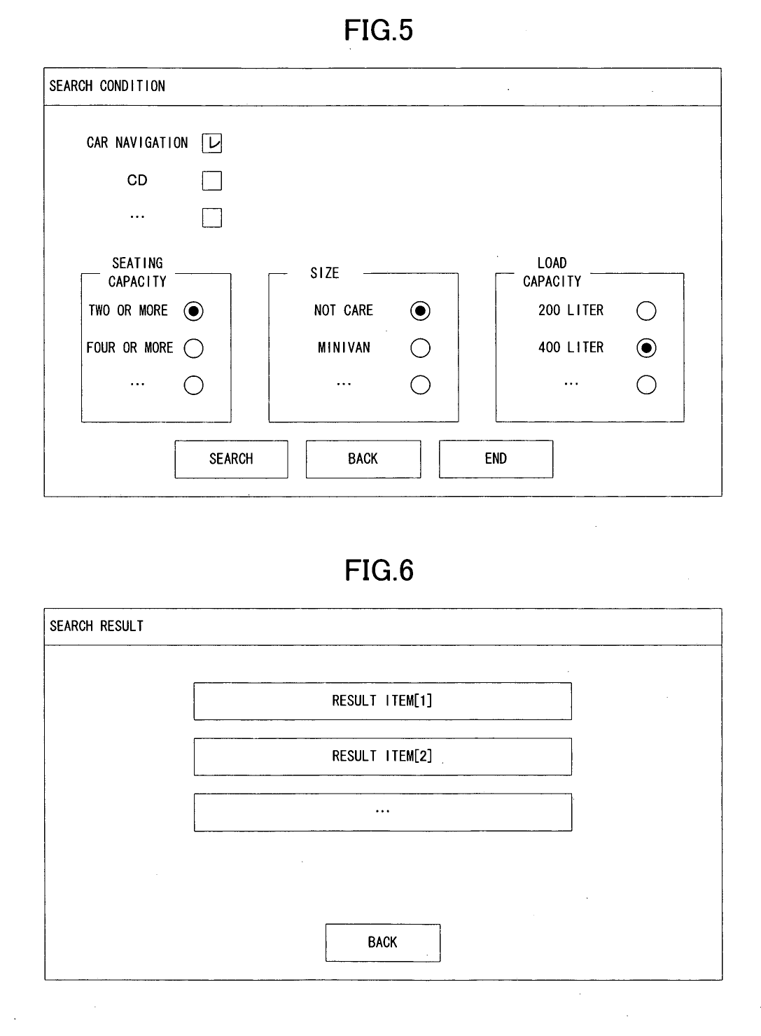

FIG. 5 is a view showing an example of the search screen on the web application according to the embodiment of the present invention. The search screen shown in FIG. 5 has: options relating to search condition, seating capacity, size, and load capacity; a search button; a back button; and an end button and receives the user's input. FIG. 6 is a view showing an example of the search result screen of the web application according to the embodiment of the present invention. The search result screen has a back button and displays a predetermined number of search result items.

Next, the test scenario template information generation section 2 generates test scenario template information based on the design information acquired by the design information acquisition section 1 and previously set test viewpoints (S12). The test scenario template information is information in which a part of components of a test scenario has been set. When the residual part of the component has been set, the test scenario is completed. The test viewpoint represents a generation rule applied in the case where different test scenario template information having the same screen transition is generated based on test scenario template information having one screen transition. As the test viewpoint, a condition for detecting an application target from the test scenario template information that has been generated first and content to be applied to the application target are shown.

Next, the test scenario template information selection section 5 determines whether there is any existing test scenario or existing test data (S21). When there is no existing test scenario or existing test data (N in S21), the flow shifts to step S31. On the other hand, when there is any existing test scenario or existing test data (Y in S21), the test scenario template information selection section 5 selects the test scenario template information to be used (S22).

The test scenario template information selection section 5 compares the existing test scenario template information and newly generated one to determine whether they are the same test scenario template information or not. When all of the transition source screens, transition destination screens, operations, applied test viewpoints are the same between the existing test scenario template information and newly generated test scenario template information, the test scenario template information selection section 5 determines that they are the same test scenario template information. When they are the same test scenario template information, the test scenario template information selection section 5 discards the newly generated test scenario template information and retains the existing test scenario template information and the test scenario and test data that have been set based on it. On the other hand, when the existing test scenario template information and newly generated test scenario template information are not the same, the newly generated test scenario template information is added to the existing test scenario template information.

Next, the test scenario setting section 3 completes setting of the test scenario by setting information that has not yet been set in the test scenario template information (S31). More specifically, the test scenario setting section 3 displays a test scenario setting screen to receive input of the information that has not yet been set from the user as well as to support the user's input operation of the test scenario.

Next, the test data setting section 4 sets the test data for use in the test scenario (S32). As is the case with the test scenario setting section 3, the test data setting section 4 displays a test data setting screen to receive input of the test data from the user as well as to support the user's input operation of the test data.

Next, the test scenario generation apparatus outputs the test scenario and test data whose setting have thus been completed as a document (S34) and ends this flow. The test scenario generation apparatus executes this flow every time the design information is changed.

The outline of the operation of the test scenario generation apparatus is as described above. Hereinafter, details of respective operations will be described.

Firstly, details of the test scenario template information generation operation (S12) will be described.

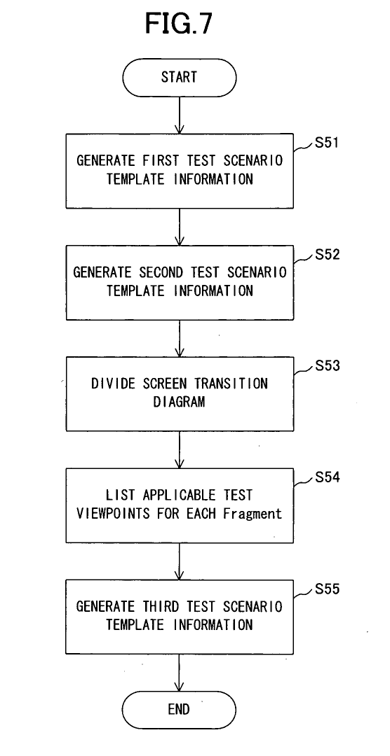

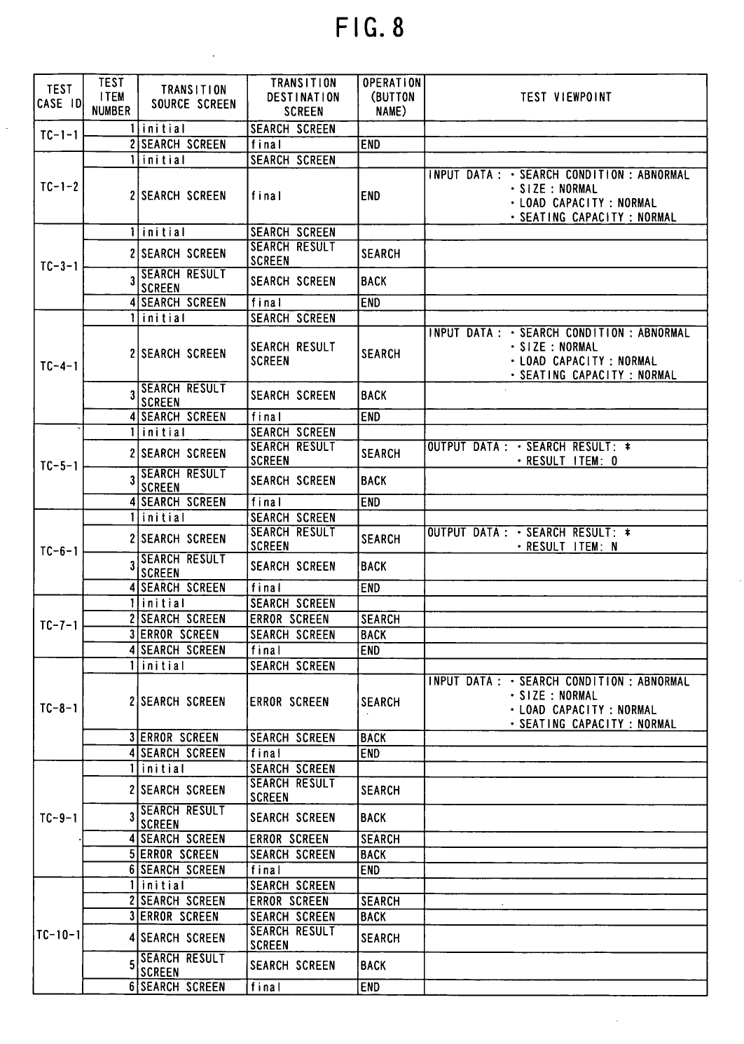

FIG. 7 is a flowchart showing an example of the test scenario template information generation operation according to the present invention. Firstly, the test scenario template information generation section 2 searches screen transition sequences in such a manner to trace all transitions in the screen transition diagram at least once to generate test scenario template information and records the generated test scenario template information in a test scenario template information list as first test scenario template information (S51). That the screen transition sequences are searched in the above manner can be realized using a prior art (refer to for example, “Software testing techniques (Japanese version)” written by Boris Beizer, translated by Akira Onoma and Tsuneo Yamaura, Nikkei BP Center, 1994, pages 63 to 64).

FIG. 8 is a document showing an example of the test scenario template information according to the embodiment of the present invention. In this case, TC-1-1, TC-3-1, and TC-7-1 are generated as the first test scenario template information. Other test scenario template information are generated in the processing to be described later.

The test scenario template information and test scenario have items of test case ID, test item number, transition source screen, transition destination screen, operation (button name), test viewpoint, respectively. In the first test scenario template information, values of test case ID, test item number, transition source screen, transition destination screen, operation (button name) have been set.

The test case ID is an identifier of the test case representing a single test scenario. The test item is a part corresponding to one screen transition included in the test scenario. The test item number is a number sequentially assigned to respective screen transitions included in the test scenario. The operation (button name) is a name of the button which has served as the trigger of the transition in the transition source screen. “initial” represents the initial screen of the respective test cases, and “final” represents the final screen.

As described above, in TC-1-1, TC-3-1, and TC-7-1, all screen transitions are exercised at least once. Although the test viewpoint is not applied to the first test scenario template information and the column of the test viewpoint is therefore left blank, input data from the user is regarded as a normal value, and the number of result items is set to a general value, for example, one.

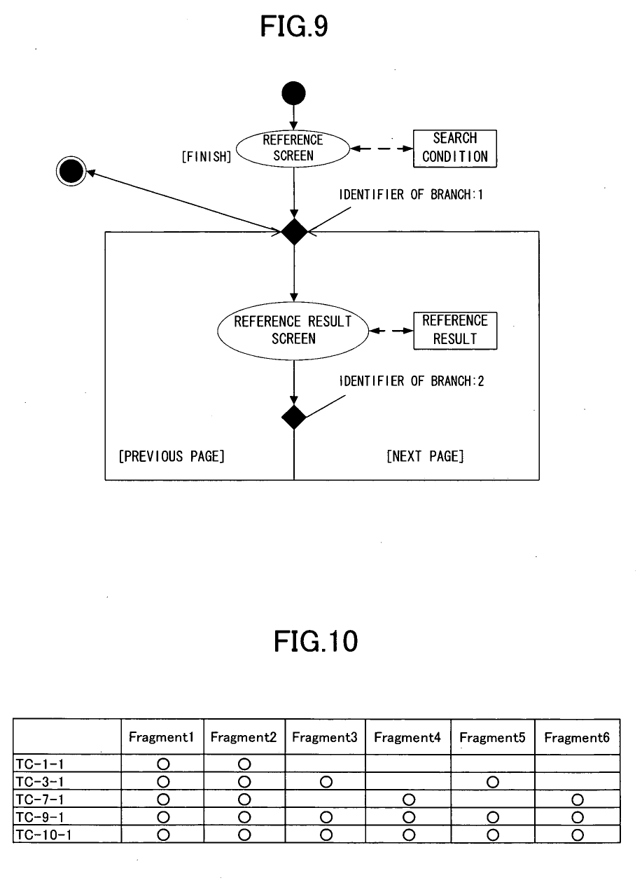

When there is any condition branch in the screen transition diagram, priority may be set on the respective branching transitions. According to the set priority, the test scenario template information generation section 2 may generate the first test scenario template information that restricts the screen transition. This is effective for a screen transition diagram that represents a state where the page is switched in the forward and back directions or screen transition diagram representing a state where a button for shifting to a sub screen for the user to set a search condition and, after the setting of the search condition, a search button is depressed. FIG. 9 is a flow graph showing an example of the screen transition diagram in which a transition priority setting is effective. The example of FIG. 9 represents a case where the page is switched in the forward and back directions. By giving higher priority to “next page” than to “previous page”, it is possible to prevent generation of test scenario template information unnecessary for operation, such as one in which “previous button” is depressed in a state where “next page” button has not been depressed even once.

Next, the test scenario template information generation section 2 generates test scenario template information that is made corresponding to the loop of the generated first test scenario template information and adds it, as second test scenario template information, to the test scenario template information list (S52). More specifically, the test scenario template information generation section 2 prepares a setting in which, for example, the number of loops of the screen transition has been specified and adds a transition that performs a loop to the generated first test scenario template information based on the prepared setting to thereby generate the second test scenario template information. The addition of a transition that performs a loop can be realized using a prior art.

Here, of the test scenario template information shown in FIG. 8, TC-9-1 and TC-10-1 are generated as the second test scenario template information. TC-9-1 is generated by adding a loop to the first test scenario template information TC-3-1. Similarly, TC-10-1 is generated by adding a loop to the first test scenario template information TC-7-1. In TC-9-1 and TC-10-1, a result screen and error screen are traced once in one direction and they are traced again in the opposite direction. As is case with the first test scenario template information, although the test viewpoint is not applied to the second scenario template information and the column of the test viewpoint is therefore left blank, input data from the user is regarded as a normal value, and the number of result items is set to a general value, for example, one.

Next, the test scenario template information generation section 2 divides the screen transition diagram into the unit (Fragment) in which propriety of application of the test viewpoint can easily be detected and records the Fragments existing in each test scenario template information as a test scenario template information table (S53). The unit (Fragment) in which propriety of application of the test viewpoint can easily be detected is, for example, user's operating unit. The screen transition diagram shown in FIG. 3 is divided into the following six Fragments.

Fragment 1. Start→Search screen

Fragment 2. Search screen→End

Fragment 3. Search screen→Result screen

Fragment 4. Search screen→Error screen

Fragment 5. Result screen→Search screen

Fragment 6. Error screen→Search screen

FIG. 10 is a table showing an example of the test scenario template information according to the embodiment of the present invention. In FIG. 10, Fragments existing in the above first and second test scenario template information are represented by “∘”.

Next, the test scenario template information generation section 2 lists applicable test viewpoints for each Fragment and records the listed test viewpoints as a Fragment table (S54). The Fragment table will be described later. The test scenario template information generation section 2 then generates test scenario template information in which the test viewpoint has been applied to the generated test scenario template information, adds it, as third test scenario template information, to the test scenario template information list (S55) and ends this flow.

Here, details of the test viewpoint will be described.

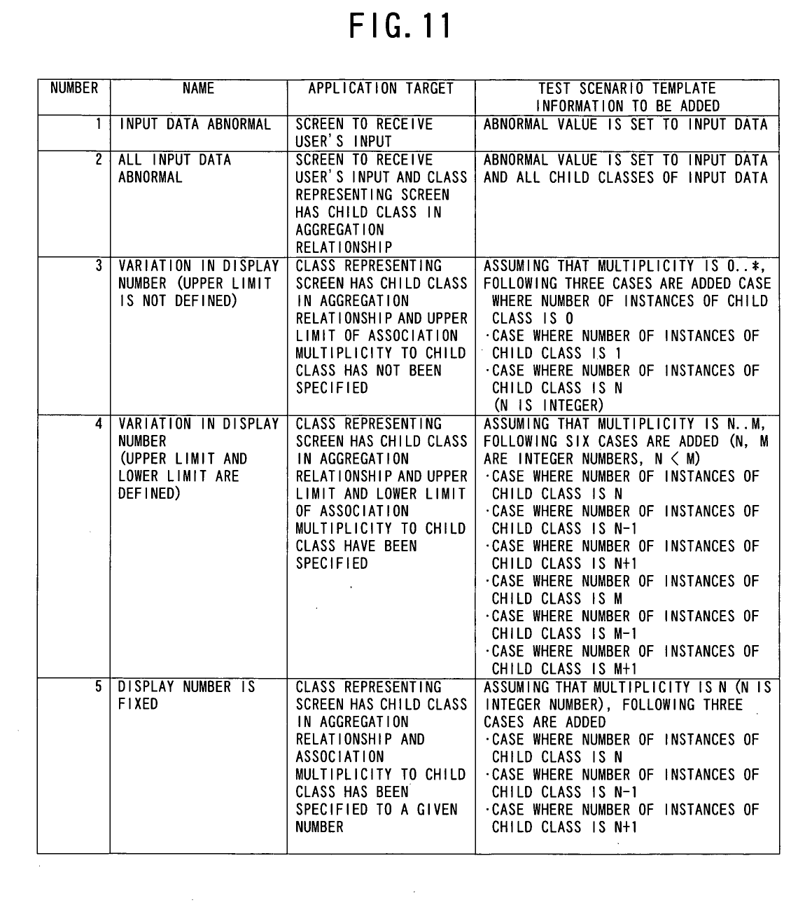

FIG. 11 is a table showing an example of the test viewpoint according to the embodiment. These test viewpoints are implemented as a class. The application target and content of the test viewpoint are implemented as a method in the class.

Test viewpoints 1 and 2 are test viewpoints for testing the case where input data from the user is an abnormal value. Test viewpoints 3, 4, and 5 are test view pints for performing a boundary value test which is widely used in testing techniques. With this viewpoint, the vicinity of the boundary value where the condition is likely to be changed is selectively tested and, for example, it is checked that when some number of result items is given to the screen on which a predetermined number of result items is allowed to be displayed, the result items to be displayed is displayed and the result items that is not allowed to be displayed is not displayed.

For the test scenario template information to which the test viewpoint 1 or test viewpoint 2 is applied, an abnormal value is set as user's input data; whereas for the test scenario template information to which the test viewpoint 1 or test view point 2 is not applied, a normal value is set as user's input data. For the test scenario template information to which the test viewpoint 3, test viewpoint 4, or test viewpoint 5 is applied, items are given by the number in the vicinity of the boundary value; whereas for the test scenario template information to which the test viewpoint 3, test viewpoint 4, or test viewpoint 5 is not applied, the general number of items is given.

In the case where test viewpoint 3 is not applied, as in the case of TC-1-1, TC-2-1, TC-3-1, TC-4-1, TC-7-1, TC-8-1, TC-9-1, and TC-10-1, a test case having one result item is generated. Although the test case is firstly generated by the test scenario template information generation section 2 with the number of the result items set to 1, the creator can add or delete the number of result items in the test data setting section 4. On the other hand, in the case where test viewpoint 3 is applied, a test case like TC-5-1, in which the number of result items is set to 0 and test case like TC-6-1, in which the number of result items is set to N (N is a sufficiently large integer number) are generated.

In the case where test viewpoint 4 is applied, the number of the test scenario template information becomes large. In order to reduce the number of the test scenario template information, the content of test viewpoint 4 may be changed as follows.

Assuming that multiplicity is N . . . M (N and M are integer numbers, N<M), the following four test scenario template information are added.

Case where number of instances of child class is N

Case where number of instances of child class is N−1

Case where number of instances of child class is M

Case where number of instances of child class is M−1

Next, details of generation of the Fragment table (S54) will be described.

The criterion based on which whether one test viewpoint can be applied to one Fragment is determined will be described. When one Fragment fits the requirement of the application target of one test viewpoint, it is determined that the test viewpoint can be applied to the Fragment. In the case of “screen that receives user's input” which is the application target of test viewpoints 1 and 2, the test scenario template information generation section 2 determines that they are applicable when an object flow that represents an input to the transition source screen exists in the screen transition diagram. For example, since the search screen receives an input of a search condition in Fragment 2, it is determined that test viewpoints 1 and 2 are applicable.

In the case of “the class representing a screen has a child class in aggregation relationship and the upper limit of the association multiplicity to the child class has not been specified” which is the application target of test viewpoint 3, the test scenario template information generation section 2 according to the embodiment determines that it is applicable when the multiplicity from a detection result class to result item class is “0 . . . *” in the screen item definition. For example, Fragment 3, since the multiplicity from the search result class to result item class is “0 . . . *”, it is determined that test viewpoint 3 is applicable.

Similarly, in the case of “the class representing a screen has a child class in aggregation relationship and the upper limit and lower limit of the association multiplicity to the child class have been specified” which is the application target of test viewpoint 4, the test scenario template information generation section 2 according to the embodiment determines that it is applicable when the multiplicity from a detection result class to result item class is N . . . M (N and M are integer numbers, N<M) in the screen item definition. Similarly, in the case of “the class representing a screen has a child class in aggregation relationship and where the association multiplicity to the child class has been specified to a given number” which is the application target of test viewpoint 5, the test scenario template information generation section 2 according to the embodiment determines that it is applicable when the multiplicity from a detection result class to result item class is N (N is integer number) in the screen item definition.

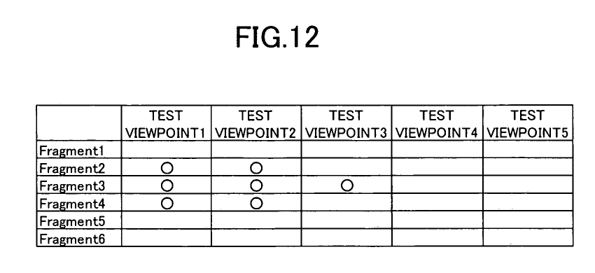

FIG. 12 is an example of the Fragment table according to the embodiment. In FIG. 12, the case where one test viewpoint is applicable to one Fragment is represented by “∘”.

Details of the third test scenario template information generation process (S55) will next be described.

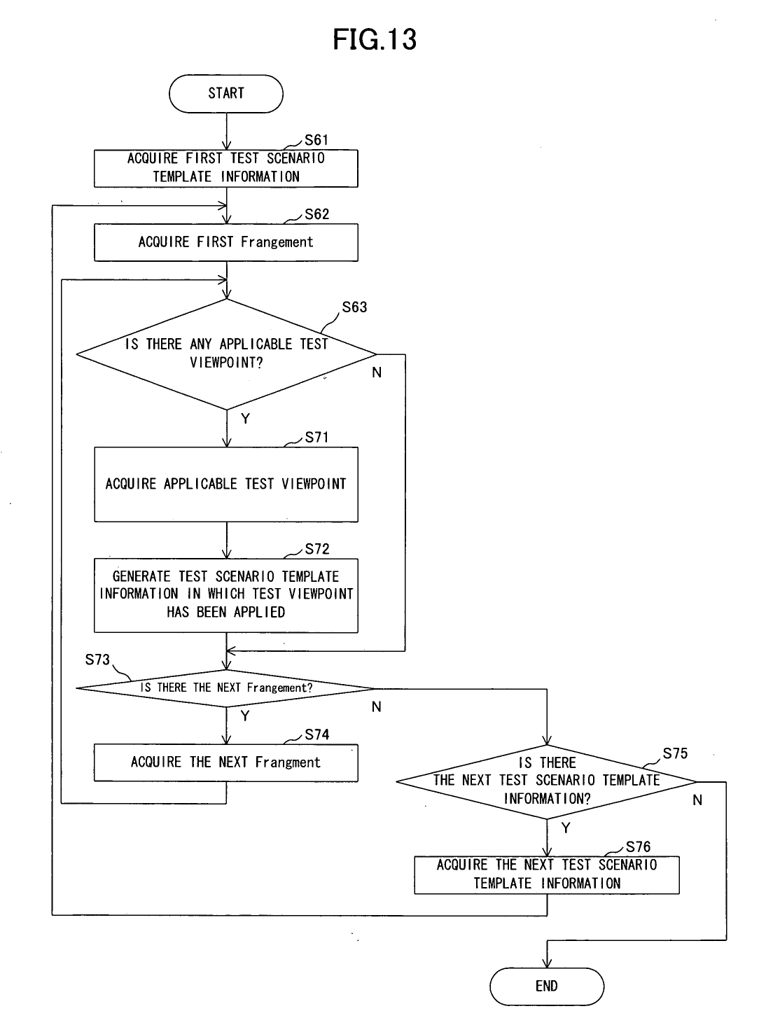

FIG. 13 is a flowchart showing an example of operation of the third test scenario template information generation process according to the present invention. Firstly, the test scenario template information generation section 2 acquires first test scenario template information to which a test view point has not been applied (S61) and acquires first Fragment in the acquired test scenario template information (S62). The test scenario template information generation section 2 then searches the test scenario template information table and Fragment table and determines whether there is any test viewpoint that is applicable to the Fragment being processed (S63).

More specifically, the test scenario template information generation section 2 refers to the test scenario template information table to specify correspondence between Fragments and respective test scenario template information. When one fragment is used in a plurality of test scenario template information, there is a possibility that the same test viewpoint is applied to the same Fragment in a plurality of test scenario template information. In order to avoid duplication of the same test, the test scenario template information generation section 2 refers to the test scenario template information table and Fragment table to determine the test scenario to which the test viewpoint corresponding to the one Fragment is applied. The test scenario template information generation section 2 may apply the test viewpoint with the above duplication allowed.

When there is no applicable test viewpoint (N in S63), the flow shifts to step S73. On the other hand, there is any applicable test viewpoint, (Y in S63), the test scenario template information generation section 2 acquires the applicable test viewpoint (S71) and generates test scenario template information in which the acquired test viewpoint has been applied to Fragment being processed (S72), and the flow shifts to step S73.

In step S73, the test scenario template information generation section 2 determines whether next Fragment can be acquired in the test scenario template information being processed (S73). When determining that the next Fragment can be acquired (Y in S73), the test scenario template information generation section 2 acquires the next Fragment in the test scenario template information being processed (S74), and the flow shifts to step S63. On the other hand, when determining that the next Fragment cannot be acquired (N in S73), the test scenario template information generation section 2 determines whether next test scenario template information can be acquired (S75). When determining that the next test scenario template information can be acquired (Y in S75), the test scenario template information generation section 2 acquires the next test scenario template information (S76) and the flow shifts to step S62. On the other hand, when determining that the next test scenario template information cannot be acquired (N in S75), the test scenario template information generation section 2 ends this flow.

Here, of the test scenario template information shown in FIG. 8, TC-2-1, TC-4-1, TC-5-1, TC-6-1, TC-8-1 are generated as the third test scenario template information. TC-2-1 is generated by applying test viewpoint 1 to the first test scenario template information TC-1-1. In TC-2-1, abnormal input data is set only in the search condition. Similarly, TC-4-1 is generated by applying test viewpoint 1 to the first test scenario template information TC-3-1. Also in this case, abnormal input data is set only in the search condition. TC-5-1 is generated by applying test viewpoint 3 to the first test scenario template information TC-3-1. In TC-5-1, the number of result items to be displayed is set to 0. Similarly, TC-6-1 is generated by applying test viewpoint 3 to the first test scenario template information TC-3-1. In TC-6-1, the number of result items to be displayed is set to N (N is a sufficiently large integer number). Similarly, TC-8-1 is generated by applying test viewpoint 1 to the first test scenario template information TC-7-1. In TC-8-1, abnormal input data is set only in the search condition.

Although the test scenario template information includes Fragment to which the test viewpoint has not been applied or Fragment to which one test viewpoint has been applied in the present embodiment, a plurality of combinable test viewpoints may be applied to a single Fragment. Although a combination of test viewpoints of the same type, that is, a combination of test viewpoints 1 and 2, or a combination of test viewpoints 3, 4, and 5 cannot be applied, a combination of test viewpoints of different types, for example, a combination of test viewpoints 1 and 3 can be applied. Further, although the test viewpoint is applied to only one of the Fragments in the test scenario template information in the present embodiment, the test viewpoint may be applied to a plurality of Fragments in the test scenario template information.

Details of the test scenario setting operation (S31) will next be described.

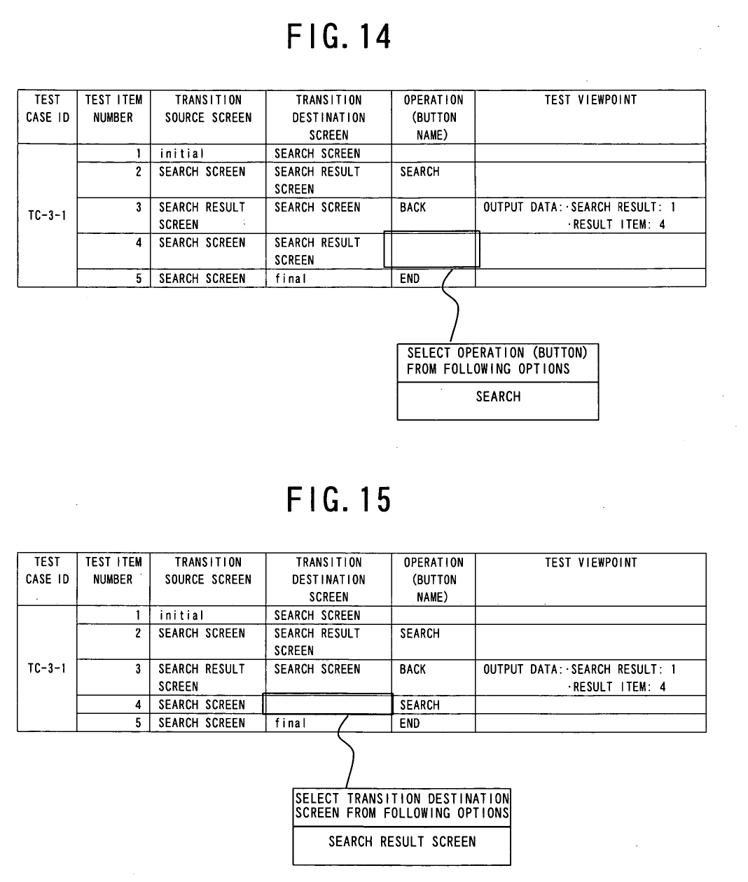

FIG. 14 is a view showing a first example of a test scenario setting screen according to the embodiment of the present invention. This screen shows a case where the creator inputs the information of “operation (button name)”. When a cursor is placed on the cell of “operation (button name)”, the test scenario setting section 3 supports the creator's input operation by detecting options of “operation (button name)” from the information of screen transition diagram, transition source screen, and transition destination screen and displaying them. The creator selects one of the displayed options and sets “operation (button name)”.

FIG. 15 is a view showing a second example of the test scenario setting screen according to the embodiment. This screen shows a case where the creator inputs the information of “transition destination screen”. When a cursor is placed on the cell of “transition destination screen”, the test scenario setting section 3 supports the creator's input operation by detecting options of “transition destination screen” from the information of screen transition diagram, transition source screen, and operation (button name) and displaying them. The creator selects one of the displayed options and sets “transition destination screen”.

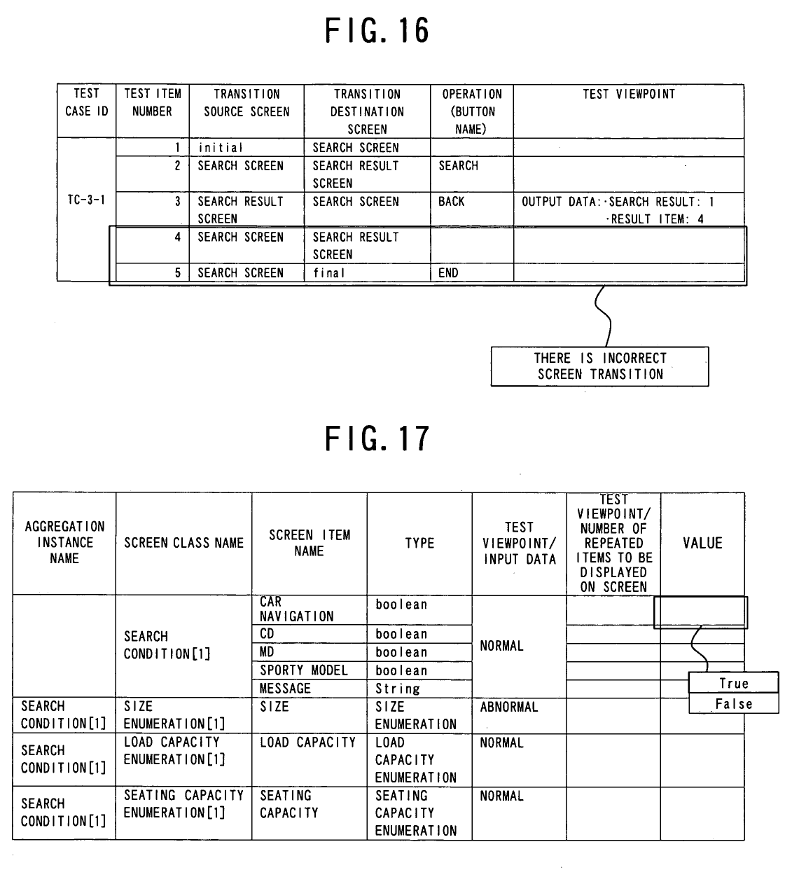

FIG. 16 is a view showing a third example of the test scenario setting screen according to the embodiment. This screen shows a case where the creator has added a test item. The addition of the test item 4 makes the transition destination screens of the test item 4 and the transition source screen of the test item 5 disagree with each other. In this case, the test scenario setting section 3 displays a message alerting that the screen transition is not correct to prompt the creator to make a correction.

Assuming that the multiplicity of the search item with respect to the search result is “0 . . . *”, test viewpoints 3 has been applied, and the number of search items is N, the test scenario setting section 3 displays a massage, saying “input a sufficiently large value” to prompt the creator to input the value of N.

The test scenario setting section 3 supports the creator's test scenario setting operation as described above. By this, an input error of the creator can be prevented and thereby an accurate test scenario can be generated. Further, it is possible to significantly increase test scenario generation efficiency.

Details of the test data setting operation (S32) will next be described.

FIG. 17 is a view showing a first example of a test data setting screen according to the embodiment. “Test viewpoint/input data” represents whether normal input data or abnormal input data is specified in the test viewpoint. Further, this screen shows a case where the creator inputs the value of screen item “car navigation”. When a cursor is placed on the cell of “value” of “car navigation”, the test data setting section 4 supports the creator's input operation by detecting options of “value” from the screen item definition and test viewpoint. In this case, since the screen item definition defines the value-type as “boolean”, the test data setting section 4 displays “True” and “False”. The creator selects one of the displayed options and sets “value”.

When the creator inputs “value” of “seating capacity” on this screen, “two or more” and “four or more” are displayed as the options of the value since this is the case where the value type is “seating capacity enumeration” and input data is normal. Further, when the creator inputs “value” of “size”, options other than “not care” and “minivan” are displayed since this is the case where the value type is “size enumeration” and input data is abnormal.

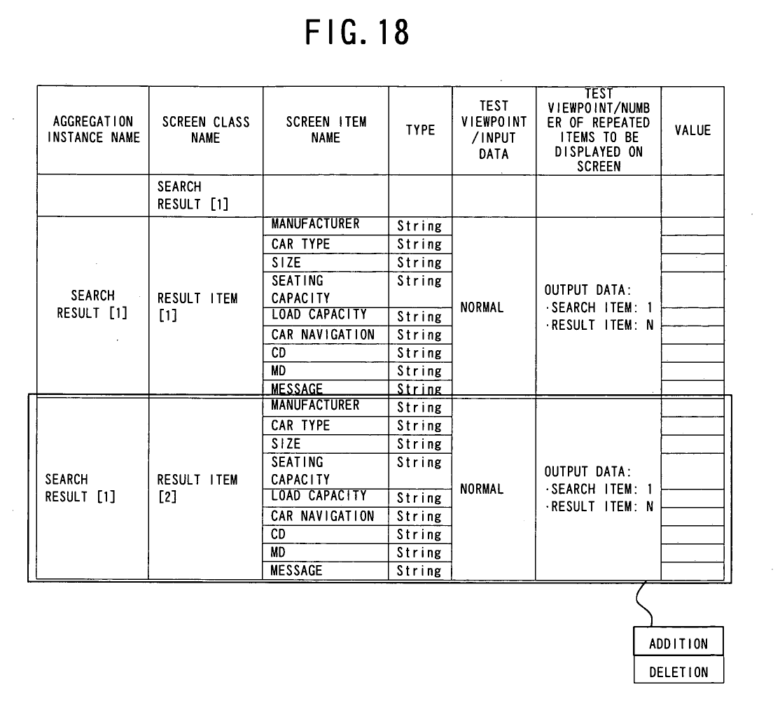

FIG. 18 is a view showing a second example of the test data setting screen according to the embodiment of the present invention. This screen shows a case where the creator changes the number of search items. When, for example, the multiplicity of search items with respect to the search results is “0 . . . *”, it is possible to freely perform addition or deletion for the search item. That is, the test data setting section 4 displays options of instructions relating to addition and deletion for the search item and prompts the user to make a selection. When, for example, the multiplicity of search items with respect to the search results is fixed to a given value, it is impossible for the user to freely perform addition or deletion for the search item. That is, the test data setting section 4 displays a specified number of search items. Further, when the multiplicity of search items with respect to the search results has the upper and lower limits, the test data setting section 4 restricts the user's addition or deletion for the search item according to the upper or lower limit.

In the present embodiment, the creator makes a selection from the adequate options displayed by the test scenario setting section 3 or test data setting section 4 before input operation, or the test scenario setting section 3 or test data setting section 4 displays the alert when the creator makes an incorrect input. Alternatively, however, the test scenario setting section 3 or test data setting section 4 may verify the validity of the creator's input at the time of saving the test scenario or test data and display the alert when detecting an incorrect input.

Further, in the present embodiment, the test scenario setting section 3 sets the test scenario based on the creator's input. Alternatively, however, values determined by the test scenario setting section 3, such as a previously prepared recommendation value or a random value within a given value may be set in the test scenario. Similarly, in the present embodiment, the test data setting section 4 sets the test data based on the creator's input. Alternatively, however, values determined by the test data setting section 4, such as a previously prepared recommendation value or a random value within a given value may be set in the test data.

Further, in the present embodiment, the test scenario template information selection section 5 selects the test scenario template information in the case where there is any existing scenario or existing data. Alternatively, however, the test scenario template information selection section 5 may be omitted in the case where the test scenario template information is generated only once.

Further, it is possible to provide a program that allows a computer constituting the test scenario generation apparatus to execute the above steps as a test scenario generation program. By storing the above program in a computer-readable storage medium, it is possible to allow the computer constituting the test scenario generation apparatus to execute the program. The computer-readable storage medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

The design information acquisition step and design information reacquisition step correspond to step S11 in the embodiment. The test scenario template information generation step corresponds to step S12 in the embodiment. The test scenario setting step corresponds to step S31 in the embodiment. The test data setting step corresponds to step S32 in the embodiment. The test scenario template information regeneration step corresponds to steps S12, S21, and S22.

What is claimed is:

1. A test scenario generation program that makes a computer execute a test scenario generation method that generates a test scenario for use in verification of an application involving screen change,
the test scenario generation program making the computer execute:
a design information acquisition step that acquires design information of the application;
a test scenario template information generation step that generates test scenario template information having a part of information of the test scenario based on the design information acquired by the design information acquisition step and a previously set generation rule; and
a test scenario setting step that sets the result of the setting that has been made for the test scenario template information based on the design information as the test scenario.

2. The test scenario generation program according to claim 1, further making the computer execute, after the test scenario setting step, a test data setting step that sets test data corresponding to the test scenario based on the design information acquired by the design information acquisition step and test scenario set by the test scenario setting step.

3. The test scenario generation program according to claim 2, further making the computer execute:
a design information reacquisition step that reacquires the design information of the application in the case where the design information of the application has been changed after the test data setting step; and
a test scenario template information regeneration step that regenerates the test scenario template information based on the design information reacquired by the design information reacquisition step and generation rule after the design information reacquisition step, determines whether the test scenario template information after the regeneration is identical to the test scenario template information before the regeneration and, in the case where they are identical to each other, uses the test scenario and test data that have been set based on the test scenario template information before the regeneration.

4. The test scenario generation program according to claim 1, wherein
the generation rule includes any of a rule that regards input data as normal in a screen that receives user's input, a rule that regards input data as abnormal in a screen that receives user's input, a rule that displays the number of items falling within a normal range in a screen in which the number of items to be displayed is variable, a rule that displays the number of items falling out of a normal range in a screen in which the number of items to be displayed is variable, a rule that displays the number of items close to the upper limit of the number of items to be displayed in which the number of items to be displayed is variable, and a rule that displays the number of items close to the lower limit of the number of items to be displayed in which the number of items to be displayed is variable.

5. The test scenario generation program according to claim 1, wherein
the design information includes a screen transition diagram that represents the screen transition of the application and screen item definition that represents definition of the components in the screen.

6. The test scenario generation program according to claim 5, wherein
the test scenario template information generation step generates the test scenario template information such that all screen transitions are used at least once and generates the test scenario template information that performs a loop of a predetermined screen transition.

7. The test scenario generation program according to claim 1, wherein
when a creator makes a setting for the test scenario template information, the test scenario setting step supports the creator's setting operation by presenting options of available setting values to the creator, by restricting the available setting values, or by alerting the creator when he or she sets an abnormal value based on the design information.

8. The test scenario generation program according to claim 2, wherein
when a creator makes a setting for the test data, the test data setting step supports the creator's setting operation by presenting options of available setting values to the creator, by restricting the available setting values, or by alerting the creator when he or she sets an abnormal value based on the design information.

9. A test scenario generation apparatus that generates a test scenario for use in verification of an application involving screen change, comprising:
a design information acquisition section that acquires design information of the application;
a test scenario template information generation section that generates test scenario template information having a part of information of the test scenario based on the design information acquired by the design information acquisition section and a previously set generation rule; and
a test scenario setting section that sets the result of the setting that has been made for the test scenario template information based on the design information as the test scenario.

10. The test scenario generation apparatus according to claim 8, further comprising a test data setting section that sets test data corresponding to the test scenario based on the design information acquired by the design information acquisition section and test scenario set by the test scenario setting section.

11. The test scenario generation apparatus according to claim 9, wherein
the design information acquisition section reacquires the design information of the application in the case where the design information of the application has been changed,
the test scenario template information generation section regenerates the test scenario template information based on the design information reacquired by the design information acquisition section, and
the test scenario generation apparatus further includes a test scenario template information selection section that determines whether the test scenario template information after the regeneration is identical to the test scenario template information before the regeneration and, in the case where they are identical to each other, uses the test scenario and test data that have been set based on the test scenario template information before the regeneration.

12. The test scenario generation apparatus according to 9, wherein
the generation rule includes any of a rule that regards input data as normal in a screen that receives user's input, a rule that regards input data as abnormal in a screen that receives user's input, a rule that displays the number of items falling within a normal range in a screen in which the number of items to be displayed is variable, a rule that displays the number of items falling out of a normal range in a screen in which the number of items to be displayed is variable, a rule that displays the number of items close to the upper limit of the number of items to be displayed in which the number of items to be displayed is variable, and a rule that displays the number of items close to the lower limit of the number of items to be displayed in which the number of items to be displayed is variable.

13. The test scenario generation apparatus according to claim 9, wherein
the design information includes a screen transition diagram that represents the screen transition of the application and screen item definition that represents definition of the components in the screen.

14. The test scenario generation apparatus according to claim 13, wherein
the test scenario template information generation section generates the test scenario template information such that all screen transitions are used at least once and generates the test scenario template information that performs a loop of a predetermined screen transition.

15. The test scenario generation apparatus according to claim 9, wherein
when a creator makes a setting for the test scenario template information, the test scenario setting section supports the creator's setting operation by presenting options of available setting values to the creator, by restricting the available setting values, or by alerting the creator when he or she sets an abnormal value based on the design information.

16. The test scenario generation apparatus according to claim 10, wherein
when a creator makes a setting for the test data, the test data setting section supports the creator's setting operation by presenting options of available setting values to the creator, by restricting the available setting values, or by alerting the creator when he or she sets an abnormal value based on the design information.

17. A test scenario generation method that generates a test scenario for use in verification of an application involving screen change, comprising:
a design information acquisition step that acquires design information of the application;
a test scenario template information generation step that generates test scenario template information having a part of information of the test scenario based on the design information acquired by the design information acquisition step and a previously set generation rule; and
a test scenario setting step that sets the result of the setting that has been made for the test scenario template information based on the design information as the test scenario.

18. The test scenario generation method according to claim 17, further comprising, after the test scenario setting step, a test data setting step that sets test data corresponding to the test scenario based on the design information acquired by the design information acquisition step and test scenario set by the test scenario setting step.

19. The test scenario generation method according to claim 18, further comprising:
a design information reacquisition step that reacquires the design information of the application in the case where the design information of the application has been changed after the test data setting step; and
a test scenario template information regeneration step that regenerates, after the design information reacquisition step, the test scenario template information based on the design information reacquired by the design information reacquisition step and generation rule, determines whether the test scenario template information after the regeneration is identical to the test scenario template information before the regeneration and, in the case where they are identical to each other, uses the test scenario and test data that have been set based on the test scenario template information before the regeneration.

20. The test scenario generation method according to claim 17, wherein
the generation rule includes any of a rule that regards input data as normal in a screen that receives user's input, a rule that regards input data as abnormal in a screen that receives user's input, a rule that displays the number of items falling within a normal range in a screen in which the number of items to be displayed is variable, a rule that displays the number of items falling out of a normal range in a screen in which the number of items to be displayed is variable, a rule that displays the number of items close to the upper limit of the number of items to be displayed in which the number of items to be displayed is variable, and a rule that displays the number of items close to the lower limit of the number of items to be displayed in which the number of items to be displayed is variable.
